(19) United States
(12) Patent Application Publication
(10) Pub. No.: US 2005/0274455 A1
(43) Pub. Date: Dec. 15, 2005

(54) Electro-active adhesive systems

(76) Inventor: Charles W. Extrand, Minneapolis, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/149,085

(22) Filed: Jun. 8, 2005

Related U.S. Application Data
(60) Provisional application No. 60/578,422, filed on Jun. 9, 2004.

(51) Int. Cl. B32B 31/00

(52) U.S. Cl. 156/272.4; 428/323; 252/62.54

(57) ABSTRACT

A method of adhesive bonding by electric field. The method includes providing at least two adherends to be bonded, providing an electro-active adhesive between the at least two adherends, wherein the electro-active adhesive includes a multiplicity of electro-active particles and an adhesive binder, and applying an electric field to change the adhesion of the electro-active adhesive system to at least one of the adherends. Various carriers for microelectronic devices including electro-active adhesive contact surfaces are also included within the scope of the invention.

### RELATED APPLICATIONS

This application claims the benefit of U.S. Provisional Patent Application No. 60/578,422, entitled ELECTRO-ACTIVE ADHESIVE SYSTEMS, filed Jun. 9, 2004, hereby fully incorporated herein by reference.

### FIELD OF THE INVENTION

This invention relates to electro-active adhesive systems that can be activated or modified by an electric field and, more specifically, to electro-active adhesive systems comprising an adhesive and a multiplicity of electro-active particles.

### BACKGROUND OF THE INVENTION

An adhesive is a substance capable of holding solid materials or adherends together by surface attachment. Adhesives have been widely used since ancient times. Archaeologists have found evidence of a substance being used as an adhesive in Babylon dating back to 4000 B.C. There is also evidence showing that glues were used as a common method of assembly in Egypt between 1500-1000 B.C. The first adhesive patent was issued in about 1750 in Britain for a glue made from fish. Later, patents were issued for adhesives using natural rubber, animal bones, fish, starch, milk protein or casein. Before 1869, the adhesives used in various applications were all natural adhesives, such as glues and natural rubbers. In 1869, the first synthetic adhesive, nitrocellulose, was invented. The development of synthetic adhesives was quickened in the beginning of the 20^{th} century. The development have led to many other synthetic adhesives, such as phenol-formaldehyde resins, polychloroprene, urea-formaldehyde adhesive, nitrile rubber-phenolic adhesives, epoxy resin adhesives, nitrile rubber-epoxy film adhesives, nylon-epoxy film adhesives, isocyanate based adhesives, hot melt adhesives, cyanoacrylate adhesives, anaerobic adhesives, silicone adhesives, high temperature resistant adhesives, hypalon toughened acrylate adhesives, bismaleimide-based adhesives, and acrylated-based or methacrylated-based adhesives.

Adhesives have been applied in many different applications to bond adherends together. The mechanical strength of the adhesive bond is determined by the chemical, physical, and mechanical properties of the adhesive and the adherends, such as surface roughness, wettability, hardness, polarity, temperature, pressure, contact surface area, and viscoelastic properties. The adherends in each application have a unique set of chemical, physical, and mechanical properties, and therefore require certain adhesive characteristics to bonded them together. As a result, many different adhesives have been developed to meet the requirements of various applications.

For many applications, activatable adhesives are desirable, particularly in those applications where a controllable adhesion is required. Some adhesives may be activated by chemicals, such as water (e.g., in glues for stamps), tackifiers, and catalysts or hardeners (e.g., in 2-part epoxy resins). Other adhesives may be activated by electromagnetic radiations or particle beams, such as ultraviolet rays, visible lights, radio frequencies, microwaves, lasers, X rays, and electron beams. There are also adhesives that may be activated by physical changes, such as temperature and pressure. Pressure sensitive adhesives have been widely used in re-positionable applications, such as post-it notes. Depending on the chemical composition, some pressure sensitive adhesives may also be activated by temperature.

In addition to the above-mentioned activatable adhesives, there are electro-active adhesives and electro-active adhesives which may be activated respectively by a magnetic field or an electric field. In general, the electro-active adhesive systems disclosed in the prior arts comprise a mixture of a curable fluid adhesive and electrically polarizable particles or a mixture of a radio-frequency sensitive ionomer and an adhesive.

The prior art also discloses substances known as electrorheological (ER) fluids. The original ER fluids were prepared in the 1940s from oil dispersions of some electrically polarizable particles, such as starch particles, lime particles, gypsum particles, carbon particles, or silica particles. Later developments of ER fluids have led to a variety of significantly improved ER fluids. The preparations, properties, and applications of the ER fluids are generally disclosed in U.S. Patent Application No. 2004/0051076 and U.S. Pat. Nos. 6,645,403, 6,635,189, 6,428,860, 6,420,469, 6,352,651, 6,277,306, 6,159,396, 6,096,235, 5,925,288, 5,910,269, 5,894,000, 5,891,356, 5,879,582, 5,863,469, 5,779,880, 5,736,064, 5,714,084, 5,711,897, 5,705,088, 5,702,630, 5,695,678, 5,693,367, 5,683,620, 5,595,680, 5,558,811, 5,558,803, 5,552,076, 5,536,426, 5,523,157, 5,516,445, 5,507,967, 5,505,871, 5,501,809, 5,498,363, 5,480,573, 5,474,697, 5,470,498, 5,445,760, 5,445,759, 5,437,806, 5,435,932, 5,435,931, 5,429,761, 5,380,450, 5,352,718, 5,336,423, 5,332,517, 5,326,489, 5,322,634, 5,320,770, 5,316,687, 5,306,438, 5,294,426, 5,294,360, 5,279,754, 5,279,753, 5,252,250, 5,252,249, 5,252,240, 5,213,713, 5,190,624, 5,149,454, 5,139,692, 5,139,691, 5,139,690, 5,130,042, 5,130,040, 5,130,039, 5,130,038, 5,108,639, 5,106,521, 5,075,021, 5,073,282, 5,071,581, 5,032,308, 5,032,307, 4,994,198, 4,992,192, 4,990,279, 4,900,387, 4,812,251, 4,772,407, 4,129,513, and 3,047,507. All of the above U.S. patent application and patents are incorporated herein by reference. Some commercial ER fluids are available form Lord Corporation (Cary, N.C.).

In general, ER fluids are fluids made by suspending extremely fine (0.01-100 microns) electrically polarizable particles in a carrier fluid of lower dielectric constant than the particles. The density of the particles may be matched as closely as possible with that of the carrier fluid to ensure good dispersion upon mixing of the ER fluid. Under the influence of an external AC or DC electric field, the initially unordered particles get oriented and stick together to form particle chains in the carrier fluid. This orientation process causes the ER fluids to gel or solidify in response to the external electric field, due to the formation of the particle chains. The change in the viscosity of the ER fluids is proportional to the applied potential, reversible when the electric field is removed, and very fast (the response time is in the order of milliseconds).

The desirable adhesive system, particularly for the microelectronic and semiconductor industries, is one whose degree of adhesion or adhesiveness to an adherend is controllable within an adhesiveness range, and is rapidly and reversibly adjustable between two or more different levels within the adhesiveness range. A rapidly and reversibly adjustable adhesive may reduce contaminations by airborne particles because the adhesiveness of the adhesive system can be turned off when it is not required.

Despite the availability of so many types of adhesives, the adhesive sciences continue to develop to meet new needs and to adapt modern technologies. This disclosure sets forth systems and materials that address these needs.

### SUMMARY OF THE INVENTION

Disclosed herein are electro-active adhesive systems and also methods of bonding at least two adherends with at least one of the electro-active adhesive systems. The electro-active adhesive systems may be activated and/or deactivated by an electric field.

One embodiment features a method of adhesive bonding comprising the steps of:

(a) providing at least two adherends to be bonded;

(b) providing an electro-active adhesive system between the at least two adherends, the electro-active adhesive system comprising a plurality of electro-active particles and an adhesive; and

(c) applying an electric field to change the adhesion of the electro-active adhesive system to at least one of the adherends.

Another embodiment features an electro-active adhesive system including a plurality of electro-active particles and an adhesive wherein the electro-active particles comprise electrically polarizable particles, the adhesive is a non-curable adhesive, and the electrically polarizable particles and the non-curable adhesive constitute an electrorheological fluid. Optionally, the electro-active adhesive system may further comprise a carrier fluid.

Another embodiment features an electro-active adhesive system including a plurality of electro-active particles and an adhesive wherein the electro-active particles comprise susceptor particles and the adhesive comprises a surface-responsive material.

Another embodiment features an electro-active adhesive system including a plurality of electro-active particles and an adhesive wherein the electro-active particles comprise susceptor particles and the adhesive comprises a shape-memory polymer.

Another embodiment features an electro-active adhesive system including a plurality of electro-active particles and an adhesive wherein the electro-active particles comprise susceptor particles and the adhesive comprises a liquid crystal polymer.

Another embodiment features a method of adhesive bonding comprising the steps of:

(a) providing at least two adherends to be bonded;

(b) providing an electro-active adhesive system between the at least two adherends, the electro-active adhesive system comprising a polymer that is capable to undergo a change in surface roughness under an electric field;

(c) applying an electric field to change the adhesion of the electro-active adhesive system to at least one of the adherends; and

(d) contacting the other adherends to the electro-active adhesive system.

Other features and advantages of the invention will be apparent from the following description of the particular embodiments thereof, and from the claims.

### BRIEF DESCRIPTION OF THE DRAWINGS

FIG. 1 is a fragmentary cross sectional view of two adherends bonded together by a layer of a electro-active adhesive according to an embodiment of the invention;

FIG. 2 is a fragmentary cross sectional view of two adherends bonded together by a layer of a electro-active adhesive and with a tie layer bonding the electro-active adhesive to one of the adherends;

FIG. 3 is a fragmentary cross sectional view of two adherends bonded together by a layer of a electro-active adhesive with a tie layer and a compatibilizer layer bonding the electro-active adhesive to one of the adherends;

FIG. 4 is a perspective view of a preferred embodiment of a matrix tray carrier with electro-active adhesive contact surfaces according to the present invention;

FIG. 5 is a cross sectional view of the carrier of FIG. 4;

FIG. 5A is a fragmentary enlarged view of a portion of FIG. 5;

FIG. 5B is a fragmentary enlarged view of a portion of FIG. 5, depicting an alternative embodiment;

FIG. 5AA is an enlarged view of a portion of FIG. 5A;

FIG. 5BB is an enlarged view of a portion of FIG. 5A depicting mechanical bonding structures for securing the component contact layer to the rigid body portion;

FIG. 5CC is an enlarged view of a portion of FIG. 5A depicting a tie layer for securing the component contact layer to the rigid body portion;

FIG. 5DD is an enlarged view of a portion of FIG. 5A depicting a multiplicity of depressions in the component contact layer for reducing the adhesiveness thereof;

FIG. 5EE is an enlarged view of a portion of FIG. 5A depicting a multiplicity of projections on the component contact layer for reducing the adhesiveness thereof;

FIG. 6 is a cross sectional view of multiple carriers in a stacked configuration;

FIG. 7 is a persective view of an alternative embodiment of a carrier with electro-active adhesive contact surfaces according to the present invention;

FIG. 8 is a cross-sectional view of the carrier depicted in FIG. 7;

FIG. 9 is a cross sectional view of multiple carriers, as depicted in FIG. 7, in a stacked configuration;

FIG. 10 is a perspective, partially exploded view of a carrier according to FIG. 7 with a separate grid structure for defining individual component retaining regions;

FIG. 11 is a cross-sectional view of the carrier depicted in FIG. 10.

FIG. 12 is a cross sectional view of an alternative embodiment of a carrier with electro-active adhesive contact surfaces according to the present invention; and

FIG. 13 is a perspective view of a carrier tape with electro-active adhesive contact surfaces according to an embodiment of the invention.

### DETAILED DESCRIPTION OF PREFERRED EMBODIMENTS

Disclosed herein is a method of adhesive bonding for holding together at least two adherends with an electro-active adhesive system that can be activated and/or deactivated by an electric field. The electric field may be a DC electric field or an alternating AC electric field. Both the DC and AC electric fields may be modulated by conventional modulation techniques. In general, the adhesiveness of the electro-active adhesive system depends on, inter alia, the strength of the electric field. The electric field should not be too low so that it is too weak to activate any effect. However, the electric field should not be too high to cause discharge or breakdown of the electro-active adhesive system or the adherends. In some embodiments, the magnitude of electric field is in the range of 0.1 to 50 kV/mm. In other embodiments, the electric field may be generated by an alternating AC voltage. Depending on the application, the AC voltage or electric field may have a frequency between 1 hz and 1000 GHz. When the AC voltage is for generating dielectric heat in a susceptor, the frequency may be in the radio frequency (RF) range of 9 khz to 1000 GHz. The RF spectrum is divided into several bands (VLF, LF, MF, HF, VHF, UHF, SHF, and EHF). The SHF (Super high frequency, from 3 GHz to 30 GHz) and EHF (Extremely high frequency, from 30 GHz to 300 GHz) bands are often referred to as the microwave spectrum.

Dielectric heating occurs when a dielectric susceptor is introduced into an AC electric field, molecules within the susceptor rotate and move many times per second in an attempt to align with the alternating AC electric field. This generates heat within the susceptor in a manner similar to friction.

The electric field may be provided by an applicator. The applicator may have different configurations. The most common configuration is in the form of two parallel plates or electrodes. Other applicator configurations include stray-field electrodes, resonant cavities or waveguides at higher frequencies. Electrodes may also form the platens or a press in pressure applications.

As depicted in FIG. 1, a first embodiment of an electro-active adhesive system 20 generally includes a electro-active adhesive 22 positioned between a pair of adherends 24 and 26 to hold them together. Electro-active adhesive 22 generally includes a multiplicity of electro-active particles mixed in an adhesive binder.

In some embodiments of this invention, electro-active adhesive 22 includes a multiplicity of electro-active particles and an adhesive binder wherein the electro-active particles are electrically polarizable particles, the adhesive binder is a non-curable adhesive, and the electrically polarizable particles and the non-curable adhesive constitute an electrorheological (ER) fluid. Optionally, electro-active adhesive 22 may further include a carrier fluid.

Any particles that may be polarized by an electric field may be used as electrically polarizable particles for the ER-based electro-active adhesive system 20 of this invention. Non-limiting examples of the electrically polarizable particles include starch, carbon-based particles (e.g, carbonaceous particles, fullerenes, carbon black, and polymer grafted carbon black), inorganic particles (e.g., lime, gypsum, metallic particles, ceramic particles, sol gel particles, titanium-based particles such as titanium oxide particles and hydrous titanium oxide particles, synthetic mica particles, aluminum borate particles, metallic silicates such as aluminum silicate and calcium silicates, and silica-based particles such as silica particles, colloidal silica and silica gel), organic particles (e.g., particles of water-adsorbing resins such as polyacrylic acid and polyamides, particles of thermoplastic resins having a carboxyl group or an ester bond, and particles of liquid crystalline polymers), surface-treated inorganic particles, surface-treated organic particles, alkali carboxylates (e.g., potassium stearate, sodium palmitate, lithium laurate, cesium myristate, rubidium behenate, and francium decanate), organic semi-conductive particles (e.g., polyathenequinones, polyphenylenevinylenes, polypyrroles, polythiophenes, polyanilines, polyphenylenes, polyacetylenes, polyphenothiazines, polyimidazoles, and their derivatives), polymeric sponge particulates, magnetizable particles (e.g., iron oxide), polymeric salts, phenoxy organometallic salts, amino acid containing metal polyoxo-salts, and silicone ionomer particles. In some embodiments of interest, the average particle diameter of the electrically polarizable particles is about 0.01 to about 100 microns. In other embodiments of interest, the average particle diameter of the electrically polarizable particles is about 0.1 to 20 microns. In further embodiments of interest, the average particle diameter of the electrically polarizable particles is about 0.5 to 5 microns. When the average particle diameter of the electrically polarizable particles is less than 0.01 micron, the viscosity of the ER fluid may be excessively high even in the absence of an electric field. When the average particle diameter is more than 100 microns, the stability of the dispersion of the electrically polarizable particles may be inferior.

Many conventional non-curable adhesives known in the art may be used as an adhesive binder in the ER-based electro-active adhesive 22 of this invention. Non-limiting examples of suitable non-curable adhesive materials include natural rubber, polychloroprene, nitrile rubber-phenolic resins, nitrile rubber-epoxy resins, nylon-epoxy resins, hot melt adhesives, anaerobic adhesives, silicone adhesives, hypalon toughened acrylate adhesives, bismaleimide-based adhesives, polyacrylates, polyvinylether adhesives, silicone rubber adhesives, polyisoprene adhesives, polybutadiene adhesives, styrene-isoprene-styrene block copolymers, polybutylene terephthalate, polyolefins, polyethylene terephthalate, styrenic block co-polymers, styrene-butadiene rubbers, polyether block polyamides, polypropylene/crosslinked EDPM rubbers, and water-based adhesives such as animal glues and latex-based adhesives. The number average molecular weight of the polymeric adhesive materials may vary from 1000 to 10,000,000 daltons.

Optionally, the ER-based electro-active adhesive 22 of this invention may include a carrier fluid. The carrier fluid may be used to adjust the properties, such as viscosity, of the ER-based electro-active adhesive 22 when such adjustment is desirable. Generally, the carrier fluid is non-conducting or weakly conducting. Non-limiting examples of suitable carrier fluid include silicone-based oils (e.g., dimethylsilicone, fluorosilicones, partially octyl substituted polydimethylsiloxanes, partially phenyl substituted dimethylsiloxanes, and alcohol-modified silicone oils), hydrocarbons (which can be straight-chain, branched, or cyclic; saturated or unsaturated; aliphatic or aromatic; or synthetic or natural), halogen-derivatives of these hydrocarbons (e.g., chlorobenzene, dichlorobenzene, bromobenzene, chlorobiphenyl, chloro diphenylmethane, fluorohydrocarbons, and perfluorohydrocarbons), mineral oils, vegetable oils (e.g., corn oil, peanut oil, and olive oil), ester compounds (e.g., ethyl benzoate, octyl benzoate, dioctyl phthalate, trioctyl trimellitate, and dibutyl sebacate), cyclic ketones, crown ethers, aliphatic monocarboxylic acids (e.g., neocapric acid), aromatic monocarboxylic acids (e.g., benzoic acid), aliphatic dicarboxylic acids (e.g., adipic acid, glutaric acid, sebacic acid, and azelaic acid), aromatic dicarboxylic acids (e.g., phthalic acid, isophthalic acid, and tetrahydrophthalic acid), and a combination thereof.

The amount of the electrically polarizable particles in the ER-based electro-active adhesive 22 may vary from 1 to 60% by weight. The amount of the non-curable adhesive may vary from 1 to 99% by weight. The amount of the carrier liquid may vary from 0 to 90% by weight. When the amount of the electrically polarizable particles is less than 1% by weight, the ER effect may be inferior. When the amount of the electrically polarizable particles is more than 60% by weight, the viscosity of the ER fluid may be too high even in the absence of an electric field.

In some embodiments of interest, the carrier liquid or the non-curable adhesive has a volume resistivity of 10¹¹ Ω.m or more at 80° C. and a visocity of 0.65 to 1000 centistokes at 25° C. When the viscosity of the carrier liquid or the non-curable adhesive is more than 1000 centistokes, the viscosity of the ER-based electro-active adhesive 22 may be too high, and the change of the viscosity by the ER effect under the application of a voltage may be too low. When the viscosity of the carrier liquid is less than 0.65 centistokes, the carrier liquid or the non-curable adhesive may vaporize, and the stability of the dispersion medium may be inferior.

The ER-based electro-active adhesive 22 of the present invention may comprise other additives. Non-limiting examples of additives include surface-active agents such as surfactants and dispersants, inorganic salts, antioxidants, antiwear agents, and the aromatic hydroxyl compounds disclosed in U.S. Pat. No. 5,683,629.

Surfactants or dispersants are often desirable to assist and stabilize the dispersion of the electrically polarizable particles. Non-limiting examples of suitable dispersants include functionalized silicone dispersants (for use in a silicone-based carrier liquid) and hydroxyl-containing hydrocarbon-based dispersants (for use in a hydrocarbon carrier liquid). Non-limiting examples of the functionalized silicone dispersants include hydroxypropyl silicones, aminopropyl silicones, mercaptopropyl silicones, and silicone quaternary acetates. Other non-limiting examples of suitable dispersants include acidic dispersants, ethoxylated nonylphenol, sorbitan monooleate, glycerol monooleate, sorbitan sesquioleate, basic dispersants, ethoxylated coco amide, oleic acid, t-dodecyl mercaptan, modified polyester dispersants, ester, amide, or mixed ester-amide dispersants based on polyisobutenyl succinic anhydride, dispersants based on polyisobutyl phenol, ABA type block copolymer nonionic dispersants, acrylic graft copolymers, octylphenoxypolyethoxyethanol, nonylphenoxypolyethoxyethanol, alkyl aryl ethers, alkyl aryl polyethers, amine polyglycol condensates, modified polyethoxy adducts, modified terminated alkyl aryl ethers, modified polyethoxylated straight chain alcohols, terminated ethoxylates of linear primary alcohols, high molecular weight tertiary amines such as 1-hydroxyethyl-2-alkyl imidazolines, oxazolines, perfluoralkyl sulfonates, sorbitan fatty acid esters, polyethylene glycol esters, aliphatic and aromatic phosphate esters, alkyl and aryl sulfonic acids and salts, tertiary amines, and hydrocarbyl-substituted aromatic hydroxy compounds, such as C₂₄₋₂₈ alkyl phenols, polyisobutenyl (Mₙ 940) substituted phenols, propylene tetramer substituted phenols, polypropylene (Mₙ 500) substituted phenols, and formaldehyde-coupled substituted phenols.

The adhesiveness (or the degree of adhesion) of an adhesive towards a particular adherend may be measured by any conventional tests of adhesive bonds. Such tests include, but are not limited to, tensile tests (e.g., ASTM D2095-72 and C-297-61 tests), shear tests (e.g, ASTM D1002-01 and D905-49 tests), peel tests (e.g, ASTM D-1781, D903, D1876, and D3167 tests), compression creep test (e.g, ASTM D2293-69 test), tension creep test (e.g, ASTM 2294-69 test), sonic and ultrasonic tests, radiography test, and X-ray test.

The adhesiveness of the ER-based electro-active adhesive 22 depends on the adhesiveness of the non-curable adhesive and the rheological properties of the ER fluid which, in turn, depend on the concentration and density of the electrically polarizable particles, particle size and shape distribution, properties of the carrier fluid, additional additives, polarity and strength of the electric field, temperature, pH, and other factors.

In the absence of an electric field, the viscosity, and thus the adhesiveness, of the ER-based electro-active adhesive 22 is low. When an electric field is applied, however, the viscosity, and thus adhesiveness of the electro-active adhesive 22 may be increased to a certain level suitable for some applications, especially for semiconductor and microelectronic applications. If the electric field is provided by a DC voltage, the strength of the electric field, and thus the adhesiveness, can be controlled by adjusting the voltage. If the electric field is provided by an alternating AC voltage, the adhesiveness will vary with the polarity and strength of the alternating electric field. This alternation in the adhesiveness may be an advantage if the change in the adhesiveness is synchronized with an automated bonding-debonding process. The adhesiveness of the ER-based electro-active adhesive 22 may be further adjusted by the concentration, density, particle size, and shape distribution of the electrically polarizable particles, the properties of the carrier fluid, the temperature, pH, and additional additives, such as fillers, rheology modifiers, anti-static agents, surfactants, dispersing agents, antioxidants, coupling agents, curing agents, and combinations thereof.

In other embodiments of this invention, the electro-active adhesive 22 includes a multiplicity of electro-active particles and an adhesive binder wherein the electro-active particles are susceptor particles and the adhesive binder is a surface-responsive material (SRM). A surface-responsive material is a material whose surface properties, such as wettablity, surface energy, and surface roughness, can be changed by an external stimulus, such as heat, pressure, and electric field. Non-limiting examples of suitable surface-responsive materials for this invention include those polymers described in Russell, “Surface-responsive materials,” Science, 297, 964 (2002); Kongtong et al., J. Am. Chem. Soc., 124, 7254 (2002); Falsafi et al., Langmuir, 16, 1816 (2000); Thanawala et al., Longmuir 16, 1256 (2000); Mori et al., Macromolecules, 27, 4093 (1994); Crevoisier et al., Science, 285, 1246 (1999); Cho et al., Macromolecules, 23, 2009 (2003); and Lee et al., Macromolecules, 31, 2440 (1998). All of the above articles are incorporated herein by reference.

The adhesiveness or tack of a surface-responsive material may generally be increased or decreased by electrical heat, depending on the chemical composition of the surface-responsive material. When it is desirable to increase the adhesiveness of the SRM-based electro-active adhesive 22 by electrical heat, the surface-responsive materials may be polymers including a low-surface-energy hydrophobic component, such as alkyl or perfluoroalkyl side chains, and a second component having a higher surface energy than the hydrophobic component. Non-limiting examples of the surface-responsive material whose adhesiveness may be increased by electrical heat include liquid crystalline polymers containing a poly(oxyethylene) backbone and n-heptylsulfonylmethyl side chains, and liquid crystalline polymers containing poly(acrylate) with a long perfluoroalkyl side chain and poly(methacrylate) with a long alkyl chain. At low temperatures, the hydrophobic component of the surface-responsive material causes at least part of the surface-responsive material to be in a highly ordered state, such as smectic phase or ordered crystalline domains. Generally, the hydrophobic component in such a highly ordered state is preferentially located at the surface. Therefore, the surface energy and the adhesiveness of the SRM-based electro-active adhesive 22 including such a surface-responsive material is low before the system 20 is activated by heat, either thermally or electrically. When the SRM-based electro-active adhesive system 20 is exposed to an electric field, the RF susceptor particles in the adhesive 22 generate heat and cause a transition, such as an isotropic transition, a melt transition, and a glass transition, in the surface-responsive material. The transition causes the low-surface-energy hydrophobic component mixing with the second component having a higher surface energy. As a result, the surface energy and thus the adhesiveness of the SRM-based electro-active adhesive 22 increase, sometimes sharply, over a narrower temperature interval. The temperature of this transition may be fine-tuned by changing the composition of the polymer.

When it is desirable to decrease the adhesiveness of the SRM-based electro-active adhesive 22 by electrical heat, the surface-responsive materials may be surface-treated elastomers having surface polar groups that can interact strongly with the surface of an adherend. Non-limiting examples of the surface-responsive material whose adhesiveness may be decreased by electrical heat include surface-treated elastomers such as polybutadienes, polyisoprenes, polychloroprenes, copolymers of butadiene-acrylonitrile, copolymers of butadiene-styrene, and copolymers of isoprene-isobutylene. The surface-treatment generates polar groups, such as carboxylic groups, on the surface of the elastomers so as to increase the surface adhesiveness of the elastomers. Non-limiting examples of suitable surface-treatment include exposing the surface to a plasma and treating the surface with an oxidizing agent, such as permanganates, chromates, perchromates, osmium tetroxide, halogens, peroxides, peroxyacids, nitric acid, nitrous acid, oxygen, ozone, perchlorates, perbromates, and periodates.

The function of the RF susceptor in the electro-active adhesive 22 is to generate electrical heat in the presence of an RF electrical field. In general, effective RF susceptors are ionic or polar compounds. The susceptor may be in the form of particles so that heat may be distributed uniformly over the system. Non-limiting examples of suitable RF susceptors include metals (e.g., aluminum, copper, and gold), metal oxides (e.g, iron oxide and ferrites), metallic alloys, silicon carbide, organic metals (e.g., polyaniline), inorganic salts (e.g., stannous chloride, zinc chloride or other zinc salt, lithium perchlorate, aluminum trihydrate, alkali or alkaline earth metal sulfate salts), organic salts (e.g., lithium acetate), quaternary ammonium salts, phosphonate compounds, phosphate compounds, and mixtures thereof. The RF susceptor may also be a polymeric ionic compound (“ionomer”) such as polystyrene sulfonate sodium salts, ethylene acrylic acid polymer, ethylene acrylic acid copolymer, ethylene acrylic acid salt, sulfonated polyesters, sulfopolyester copolymer, and sulfopolyester salt. Other ionomers include starch and polysaccharide derivatives such as phosphorylated starch, polysulfonated or polysulfated derivatives, including dextran sulfate, pentosan polysulfate, heparin, heparan sulfate, dermatan sulfate, chondroitin sulfate, a proteoglycan and the like. Other ionomers include proteins such as gelatin, soy protein, casein, sulfonated novolak resins, lignosulfonates and their sodium salts, and urethane ionomers. In some embodiments, the ionomer susceptor may function as both the susceptor and the adhesive and therefore the susceptor and the adhesive are chemically the same.

All conventional RF susceptor materials disclosed in the art may be used for the electro-active adhesive 22 of this invention. Some known RF susceptors have been disclosed in U.S. Pat. Nos. 6,649,888, 6,617,557, 6,600,142, 5,804,801, 5,798,395, and 5,603,795, all of which are incorporated herein by reference.

The SRM-based electro-active adhesive 22 may further include additives, such as fillers, tackifiers, flow aids, heat and UV stabilizers, coupling agents, surfactants, polar solvents, plasticizers, waxes and other organic compounds.

As discussed above, when there is a change in temperature causing a transition in the surface-responsive material of the SRM-based electro-active adhesive 22, the adhesiveness of the SRM-based electro-active adhesive 22 may be increased or decreased by turning on or off an electric field. When the change in temperature is caused by an electric field provided by an AC voltage, the adhesiveness will vary with the polarity and strength of the alternating electric field. This alternating variation in the adhesiveness may be an advantage if the change in the adhesiveness is synchronized with an automated bonding-debonding process. The adhesiveness of the surface-responsive-material-based electro-active adhesive 22 may also be adjusted by the concentration, density, particle size and shape distribution of the RF susceptor particles, the temperature, and additional additives, such as fillers, rheology modifiers, tackifiers, anti-static agents, surfactants, dispersing agents, antioxidants, coupling agents, curing agents, and combinations thereof.

In other embodiments, the electro-active adhesive 22 includes a mulitplicity of electro-active particles and an adhesive binder wherein the electro-active particles are susceptor particles and the adhesive binder is a shape-memory polymer (SMP). The SMPs are polymers that exhibit a shape-memory effect. In general, the SMPs are chemically characterized as phase segregated linear block co-polymers having a hard segment and a soft segment. The hard segment is typically crystalline with a defined melting point, and the soft segment is typically amorphous with a defined glass transition temperature. In some embodiments, however, the hard segment is amorphous and has a glass transition temperature rather than a melting point. In other embodiments, the soft segment is crystalline and has a melting point rather than a glass transition temperature. Generally, the melting point or glass transition temperature of the soft segment is substantially less than the melting point or glass transition temperature of the hard segment.

When an SMP is heated above the melting point or glass transition temperature of the hard segment, the SMP can be shaped permanently. This permanent shape can be memorized by cooling the SMP below the melting point or glass transition temperature of the hard segment. When the permanently shaped SMP is cooled below the melting point or glass transition temperature of the soft segment while the permanent shape is deformed to form a temporary shape, the temporary shape is fixed. The permanent shape is recovered by heating the SMP above the melting point or glass transition temperature of the soft segment but below the melting point or glass transition temperature of the hard segment. In another method for setting a temporary shape, the SMP is deformed at a temperature lower than the melting point or glass transition temperature of the soft segment, resulting in stress and strain being absorbed by the soft segment. When the SMP is heated above the melting point or glass transition temperature of the soft segment, but below the melting point (or glass transition temperature) of the hard segment, the stresses and strains are relieved and the SMP returns to its permanent shape. The recovery of the permanent shape, which is induced by heat, is called the shape-memory effect.

When the soft segments of the SMPs undergo a melt or glass transition, some of the physical properties of the SMPs, such as elastic modulus, hardness, and adhesiveness (or tackiness) may be changed significantly. The elastic modulus of some SMPs may be changed by a factor of up to 200 when heated above the melting point or glass transition temperature of the soft segment. Similarly, the hardness of some SMPs may be changed dramatically when the soft segment is at or above its melting point or glass transition temperature. The permanent and temporary shape of the SMPs may be designed or programmed such that a transition from a permanent shape (or temporary shape) to a temporary shape (or permanent shape) may cause an increase or a decrease in contact surface area between the SMP-based electro-active adhesive 22 and the adherends. Since the adhesiveness of the SMPs depends on their elastic modulus, hardness, and contact surface area with the adherends, the adhesiveness of SMP-based electro-active adhesive 22 may be controlled electrically by changing their temperature by heating the susceptor particles in the system with an electric field.

In some embodiments of interest, the SMP is a copolymer based on oligo(ε-caprolactone) dimethacrylate and n-butyl acrylate, commercially available from mnemoScience (Aachen, Germany, http://www.mnemoscience.de/) or VERIFLEX™ shape memory polymer systems, commercially available from Cornerstone Research Group, Inc. (Dayton, Ohio, http://www.crgrp.net/veriflex.htm). The physical properties of the copolymer of oligo(ε-caprolactone) dimethacrylate and n-butyl acrylate, such as the tackiness, cross-link density, and transition temperature, may be adjusted by varying the relative amounts of oligo(ε-caprolactone) dimethacrylate and n-butyl acrylate in the copolymer.

Other non-limiting examples of SMPs include special blends of two or more polymers selected from the group consisting of polynorborene-based polymers, polyisoprene-based polymers, polystyrene butadiene-based polymers, and polyurethane-based polymers, vinyl acetate-based polymers, and polyester-based polymers. Some of these SMP's are described in Kim, et al., “Polyurethanes having shape memory effect,” Polymer 37(26):5781-93 (1996); Li et al., “Crystallinity and morphology of segmented polyurethanes with different soft-segment length,” J. Applied Polymer 62:631-38 (1996); Takahashi et al., “Structure and properties of shape-memory polyurethane block copolymers,” J. Applied Polymer Science 60:1061-69 (1996); Tobushi H., et al., “Thermomechanical properties of shape memory polymers of polyurethane series and their applications,” J. Physique IV (Colloque C1) 6:377-84 (1996); U.S. Pat. Nos. 5,506,300; 5,145,935; 5,665,822; and Gorden, “Applications of Shape Memory Polyurethanes,” Proceedings of the First International Conference on Shape Memory and Superelastic Technologies, SMST International Committee, pp. 115-19 (1994). All of the above references are incorporated herein by reference.

The preparations, properties, and applications of SMP have also been disclosed in Lendlein et al., “Shape-Memory Polymers,” Encyclopedia of Polymer Science and Technology, Vol. 4, Third Edition, Wiley Publishers (2003); Lendlein et al., “Shape-Memory Polymers,” Angew. Chem. Int. Ed., 41(12), Pages 2034-2057 (2002); Lendlein et al., “AB-Polymer Network Based On Oligo(ε-Caprolactone) Segments Showing Shape-Memory Properties,” Proc. Natl. Acad. of Sci. USA, Vol. 98(3), p. 842 (2001); and U.S. Pat. Nos. 6,720,402, 6,388,043, 6,370,757, 6,293,960, 6,224,610, 6,160,084, 6,102,933, 6,102,917, 6,086,599, 5,957,966, 5,910,357, 5,189,110, 5,128,197, 5,093,384, 5,049,591, 5,043,396, and 4,945,127. All of the above references are incorporated herein by reference.

As mentioned above, when there is a change in temperature causing a transition in the soft segments of the SMP, the contact surface area and/or the tackiness of SMP-based electro-active adhesive 22 may be increased or decreased by turning on or off an electric field. The adhesiveness of the SMP-based electro-active adhesive 22 may also be adjusted by the concentration, density, particle size and shape distribution of the RF susceptor particles, temperature, and additional additives, such as fillers, rheology modifiers, tackifiers, anti-static agents, surfactants, dispersing agents, antioxidants, coupling agents, curing agents, compatibilizers, plasticizers, and combinations thereof.

In further embodiments, the electro-active adhesive 22 includes a mulitplicity of electro-active particles and an adhesive binder wherein the electro-active particles are susceptor particles and the adhesive binder is a liquid crystal polymer (LCP). The ability of an LCP to align along an external field is caused by the polar nature of the molecules of the LCP. Permanent electric dipoles result when one end of a molecule has a net positive charge while the other end has a net negative charge. When an external electric field is applied to the LCP, its molecules tend to orient themselves along the direction of the field. The orientation of the molecules of the LCP, which depends on both the liquid crystal nature of the LCP and its dielectric anisotropy, may be controlled by varying the frequency of the alternating electric field. In some embodiments, a 90-degree flip in the molecular orientation of a LCP may be induced by changing from a high-frequency (>1000 hertz) to a low-frequency (<50 hertz) electric field. Therefore, when the molecules in the LCP are oriented in a direction such that the polar end groups are perpendicular to the plane of the surface, the surface has a high surface energy, and thus a high level of adhesiveness. When the molecules in the LCP are oriented in a direction such that the polar end groups are parallel to the plane of the surface, the surface has a low surface energy, thus a low level of adhesiveness. The orientation of liquid crystal polymer by an AC electric field is described by Korner et al., in “Orientation-On-Demand Thin Films: Curing of Liquid Crystalline Networks in AC Electric Fields,” Science, Vol. 272, 252-255 (1996), which is incorporated herein by reference.

It has been known that LCPs, such as thermotropic LCPs, can be used as hot melt adhesives. Suitable thermotropic LCPs include liquid crystal polyesters, liquid crystal polycarbonates, liquid crystal polyetheretherketone, liquid crystal polyetherketoneketone and liquid crystal polyester imides, specific examples of which include (wholly) aromatic polyesters, polyester amides, polyamide imides, polyester carbonates, polyazomethines, and aromatic LCPs containing sulfonated ionic monomer units. Some useful thermotropic LCPs are disclosed in U.S. Pat. Nos. 3,778,410, 3,804,805, 3,890,256, 4,458,039, 4,863,767, 5,227,456, and 6,602,583, all of which are incorporated herein by reference.

The term liquid crystalline polymer for the purposes of this application may include, without limitation, blends of a LCP with polymers that are not liquid crystalline polymers. Some of these blends have processing and functional characteristics similar to liquid crystalline polymers and are thus included within the scope of the present invention. In some embodiments, the non-LCP and LCP components are generally mixed in a weight ratio of 10:90 to 90:10. In other embodiments, the non-LCP and LCP components are a weight ratio of 30:70 to 70:30.

Some non-limiting examples of suitable LCPs for this invention include mostly or fully aromatic liquid crystalline polyesters, such as VECTRA™ (commercially available from Ticona), XYDAR™ (commercially available from Amoco Polymers), and ZENITE™ (commercially available from DuPont), and copolymer of hydroxy benzoate/hydroxy naphthoate, such as VECSTAR™ (commercially available from Kuraray Co., Ltd., Japan). Additional additives, such as fillers, rheology modifiers, tackifiers, anti-static agents, surfactants, dispersing agents, antioxidants, coupling agents, curing agents, compatibilizers, plasticizers, and combinations thereof may be added to the LCP to controlled the performance of the LCP-based electro-active adhesive 22.

As mentioned earlier, the molecular orientation of LCP may be changed by changing from a high-frequency (>1000 hertz) to a low-frequency (<50 hertz) electric field. This phenomenon may be used to change reversibly the adhesiveness of the LCP-based electro-active adhesive 22. First, the LCP may be changed from the solid state to the molten state by heating the susceptor particles in LCP-based electro-active adhesive 22 by application of an AC electric field at a first frequency. Second, the orientation of the molecules of the LCP in LCP-based electro-active adhesive 22 is controlled by application of an AC electric field at a second frequency. The first frequency and the second frequency may be the same or different. By controlling the molecular orientation, the adhesiveness of the LCP may be adjusted when the end groups of the LCP molecules are chemically different from the rest of the molecules. In some embodiments of interest, the end groups of the LCP are polar and have a high surface energy and the rest of the molecules have a lower surface energy than the end groups.

Some embodiments of the present invention feature a method of adhesive bonding comprising the steps of (1) providing at least two adherends to be bonded; (2) applying an electro-active adhesive 22 on one of the at least two adherends, the electro-active adhesive 22 including a polymer that is capable to undergo a change in surface roughness under an electric field so as to affect the adhesion between electro-active adhesive 22 and the adherends; (3) applying an electric field to change the surface roughness and thus the adhesion of the electro-active adhesive system; and (4) contacting the other adherends to the electro-active adhesive 22.

Many polymers, either in solid or liquid state, can undergo a deformation, such as a change in surface roughness, under an electric field. Such deformation is caused by electrohydrodynamic instability. In some embodiments, the electric field is provided by an AC voltage so that charge injection into the polymer is minimized. The applied voltage may be between 1 to 1000 V. Most polymers can exhibit electrohydrodynamic instability in an electric field, particularly at a temperature above their glass transition temperatures or melting temperatures. Some non-limiting examples of such polymers that may exhibit electrohydrodynamic instability in an electric field include polyurethane, poly(butylene terephthalate), polyolefins, poly(ethylene terephthalate), styrenic block co-polymers, styrene-butadiene rubber, polyether block polyamide, polypropylene/crosslinked EDPM rubber, polymethylmethacrylate, polyisoprene, polybutadiene, polychloroprene, poly(dimethyl siloxane), nitrile rubber-phenolic resins, epoxy resins, nitrile rubber-epoxy resins, nylon-epoxy resins, polyacrylates, polyvinylether, polyisoprene adhesives, polybutadiene, styrene-isoprene-styrene block copolymers, phenol-formaldehyde resins, urea-formaldehyde resins, and latex-based adhesives. In some embodiments of interest, the polymer is selected from the group consisting of poly(dimethyl siloxane), polyisoprene, polybutadiene, styrene-isoprene-styrene block copolymers, polyurethanes, poly(butylene terephthalate), polyolefins, poly(ethylene terephthalate), styrenic block co-polymers, styrene-butadiene rubbers, polyether block polyamides, and polypropylene/crosslinked EDPM rubbers.

Some polymers that exhibit electrohydrodynamic instability in an electric field are disclosed in Assender et al., “How Surface Topography relateds to Materials' Properties,” Science, Vol. 297, p. 973 (2002); Schäffer et al., “Electrohydrodynamic instabilities in polymer film,” Europhysics Letters, 53(4), 518-524 (2001); Schäffer et al., “Electrically induced structure formation and pattern transfer”, Nature, Vol. 403, 874-877 (2000); and Appl. Phys. Lett, 82(15), 2404 (2003), all of which are incorporated herein by reference.

As depicted in FIG. 2, electro-active adhesive system 20 may further include a conventional adhesive or tie layer 28 positioned between adherend 26 and electro-active adhesive 22 to improve adhesion between electro-active adhesive 22 and adherend 26. It will be appreciated that layer 28 may be positioned between electro-active adhesive 22 and either or both adherends 24, 26, as desired.

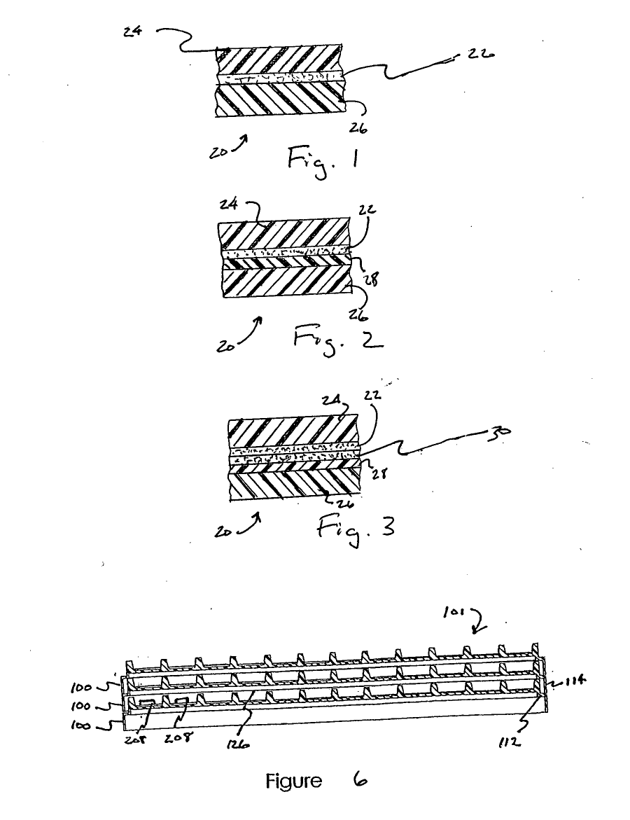

Moreover, as depicted in FIG. 3, a compatibilizer layer 30 may be provided between tie layer 28 and electro-active adhesive 22 to improve adhesion therebetween. Compatibilizer layer 30, which is preferably selected so as to be compatible with both the tie layer 28 and electro-active adhesive 22, may include a polymeric material such as block co-polymers and graft co-polymers.

The electro-active adhesive systems 20 of this invention are versatile because they encompass a wide range of constructions and compositions. They are particularly suitable for those applications require controllable and/or reversible adhesives. Furthermore, their formulations may be adjusted or fine-tuned for bonding a variety of adherends found in the semiconductor industry and microelectronic industry.

An adherend may be any solid material to which an adhesive adheres. There are many different kinds of adherend materials. Adherend materials almost include all known solids. Some interesting common adherend materials include woods, plastics, metals, ceramics, papers, cements, clothes, fabrics, silks, leathers, glasses, semiconductor materials (e.g., silicon wafers and chips), and microelectronic materials (e.g., read/write heads).

In some embodiments of this invention, an electro-active adhesive 22 according to the invention is used to bond semiconductor and/or microelectronic components, such as silicon wafers, chips, and read/write heads, to a transporting and/or storing device, such as a matrix tray, a read/write head tray, a chip tray, a carrier tape, a carrier sheet, or a film frame. The above-mentioned trays or film frames may be made of materials selected from the group consisting of acrylonitrile-butadiene-styrene, polycarbonate, urethane, polyphenylene sulfide, polystyrene, polymethyl methacrylate, polyetherketone, polyetheretherketone, polyetherketoneketone, polyether imide, polysulfone, styrene acrylonitrile, polyethylene, polypropylene, fluoropolymer, polyolefin, nylon, and combinations thereof. The adhesive in the electro-active adhesive system for these embodiments may be a thermoplastic vulcanizate material or a polymeric elastomer material having, a relatively soft surface, and ESD safe properties. Non-limiting examples of polymeric elastomer material include polyurethane, polybutylene terephthalate, polyolefins, polyethylene terephthalate, styrenic block co-polymers (e.g. Kraton®), styrene-butadiene rubber, and nylon in the form of polyether block polyamide. Non-limiting examples of thermoplastic vulcanizate material include polypropylene/crosslinked EDPM rubber,. such as Santoprene® made by Advanced Elastomer Systems of Akron, Ohio.

The electro-active adhesive 22 for bonding the semiconductor and/or microelectronic components to the transporting and/or storing device may have a surface energy between 20 dyne/cm and 100 dyne/cm, more preferably between about 30 dyne/centimeter to 45 dyne/centimeter, and most preferably about 40 dyne/centimeter. The surface electrical resistivity of the electro-active adhesive systems may be between about 1×10⁴ ohms/square and 1×10¹² ohms/square. Optionally, an anti-static additive, such as conductive salts, carbon powders, carbon fibers, metallic particles, conductive polymers, and other electrically conductive fillers, may be added to the electro-active adhesive system to achieve the desired surface electrical resistivity. Non-limiting examples of conductive polymers include doped polyaniline, polypyrrole, polythiophene, polyisothianaphthene, polyparaphenylene, polyparaphenylene vinylene, polyheptadiyne, and polyacetylene. Non-limiting examples of conductive salts include quaternary ammonium salts, sulfonium salts, alkyl sulfonates, alkyl sulfates, alkyl phosphates, ethanol amides, ethanol amines, or fatty amines. Any other method or material may be used for the purpose which provides the requisite electrical properties along with the desired surface energy.

The amount of adhesion provided by the electro-active adhesive 22 may be adjusted for particular applications. This adjustment may be accomplished by selecting the adhesive binder material used for the electro-active adhesive 22, or through alterations to the roughness, geometry and dimensions of the surface of the adherends. Furthermore, the adjustment may be achieved by adding to the electro-active adhesive 22 additional additives, such as fillers, rheology modifiers, tackifiers, surfactants, dispersing agents, antioxidants, coupling agents, curing agents, and combinations thereof. Any of the additives mentioned-above may change the surface energy, the viscoelastic properties, or the relative hardness of the electro-active adhesive system. Generally, it is desired that the electro-active adhesive system can provide a degree of adhesion to a component per unit area of the component at least greater than the corresponding gravitational force per unit area of the component, thus permitting retention of the component even when the tray is inverted. It is most preferred that the amount of adhesion be sufficient to retain the components under shock and vibration loads typically encountered during shipping and handling operations.

Carriers are used in the micro-electronic industry for storing, transporting, fabricating, and generally holding small components such as, but not limited to, semi-conductor chips, ferrite heads, magnetic resonant read heads, thin film heads, bare dies, bump dies, substrates, optical devices, laser diodes, preforms, and miscellaneous mechanical articles such as springs and lenses.

In some embodiments, the present invention includes a carrier for handling semiconductor devices and other small components wherein the component has a surface area that can be placed into direct contact with an electro-active adhesive contact surface on the carrier. The carrier is suitable for any type of component, including those having no projections or leads, such as bare or leadless chips, but may also be used with devices having leads such as Chip Scale Package (CSP) devices. The devices may be retained on the carrier without the use of lateral or vertical physical restraints apart from the electro-active adhesive contact surface itself.

In some embodiments, one of the at least two adherends is a carrier tape or a film frame for storing and transporting electronic devices, such as integrated circuit chips, and the other adherends are the electronic devices. Carrier tapes having an adhesive tape are disclosed in U.S. Pat. Nos. 4,760,916 and 4,966,282, and some film frames having an adhesive layer are disclosed in U.S. Pat. No. 5,833,073. All of the above-mentioned patents are incorporated herein by reference. An electro-active adhesive 22 may be applied as an outermost layer on the carrier tape or the film frame, which may or may not have an inner layer of another adhesive known in the art. The electronic devices are held to the carrier tape or the film frame by the electro-active adhesive system when it is activated by applying or removing an electric field, depending on the composition of the electro-active adhesive system. When the electronic devices need to be picked up manually or by a robot, the electro-active adhesive system may be deactivated correspondingly by removing or applying an electric field.

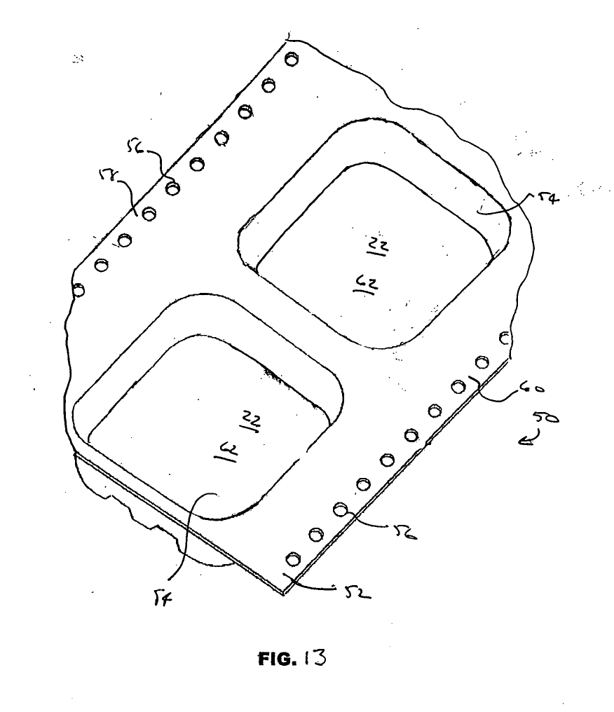

An embodiment of a carrier tape with electro-active adhesive is depicted in FIG. 13. Carrier tape 50 generally includes a body portion 52 made from generally flexible polymer material with a plurality of pockets 54 defined therein in a continuous sequence along the length of the tape 50. A continuous sequence of sprocket holes 56 is defined along one or both lateral margins 58, 60, of body 52 to enable tape 50 to be engaged and advanced by sprockets (not depicted) operated by process equipment (not depicted). According to the invention, a layer of electro-active adhesive 22 is applied to the bottom of each pocket 54 to serve as a contact surface 62 for securing an article placed in pocket 54 in direct contact with contact surface 62. Although contact surface 62 is depicted in FIG. 13 as being flat, it will be appreciated that electro-active adhesive 22 could be applied to a surface of any shape within pocket 54 to form a contact surface 62. Moreover, in carrier tape embodiments without pockets, it will be appreciated that electro-active adhesive 22 could be applied to any structure on the carrier tape, such as a raised pedestal, to form a contact surface for securing an article.

In other embodiments, one of the adherends is a carrier in the form of a chip tray or matrix tray for storing and transporting microelectronic components, such as chips, other semiconductor devices, and read/write heads, and the other adherends are the microelectronic components. Chip trays having an adhesive layer are disclosed in U.S. Pat. Application Publication No. 2004/0047108, which is incorporated herein by reference. An electro-active adhesive 22 is applied as an outermost layer on the chip tray, which may or may not have an inner layer of another adhesive known in the art. The microelectronic components are held to the chip tray by the electro-active adhesive system when it is activated by applying or removing an electric field, depending on the composition of the electro-active adhesive system. When the microelectronic components need to be picked up manually or by a robot, the electro-active adhesive system may be deactivated correspondingly by removing or applying an electric field.

Prior matrix trays having an adhesive layer are disclosed in U.S. Pat. Application Publication No. 2004/0048009, U.S. Pat. No. 5,481,438, and Japanese laid open patent application JP 05-335787, all of which are incorporated herein by reference.

According to the present invention, an electro-active adhesive 22 is applied as an outermost layer on a matrix tray, which may or may not have an inner layer of another adhesive known in the art. The semiconductor devices are held to the read/write head tray by the electro-active adhesive system when it is activated by applying or removing an electric field, depending on the composition of the electro-active adhesive system. When the semiconductor devices need to be picked up manually or by a robot, the electro-active adhesive system may be deactivated correspondingly by removing or applying an electric field.

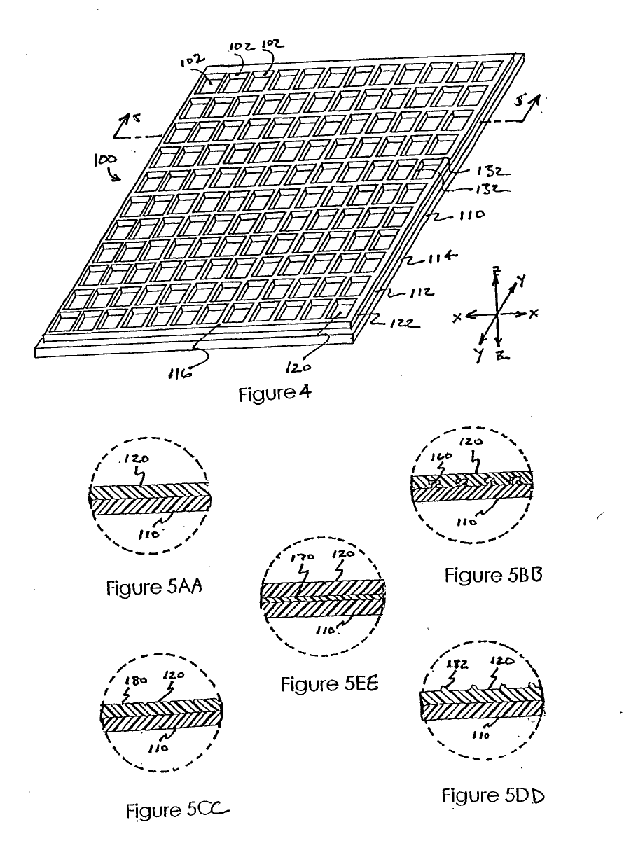

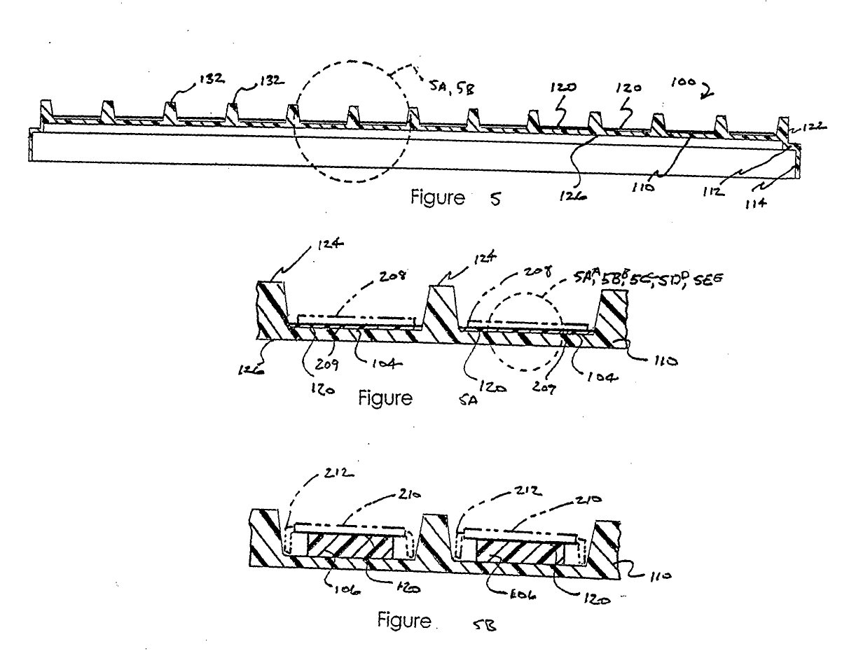

FIGS. 4 and 5 depict a preferred embodiment of a carrier according to the invention in the form of matrix tray 100. Tray 100 has rigid body portion 110 in which is formed a plurality of individual component receiving pockets 102 arranged in a matrix and oriented in a plane defined by the “x” and “y” axes as shown. Each pocket 102 has a depth dimension oriented in the “z” axis direction and contains at least one electro-active adhesive component contact surface 120 for engaging and retaining a single component. Body portion 110 preferably has a peripheral border region 112 projecting laterally outward beyond the edge 122 of matrix portion 116. A downwardly projecting skirt 114 may be provided on body portion 110. The skirt 114 is positioned so as to engage the peripheral border region 112 of a tray located immediately below when multiple trays are stacked as depicted in FIG. 6. As an alternative to skirt 114, other structures such as downwardly projecting legs or posts may be used to facilitate stacking of multiple trays. It will be appreciated that although the pockets 102 are shown as being formed integrally in rigid body portion 110, other configurations wherein component receiving pockets or other structures are formed are contemplated and are within the scope of the invention. For example, the pocket defining cross members 132 may be formed in a separate grid work piece and attached to the remainder of rigid body portion 110 using adhesives, fasteners or other means.

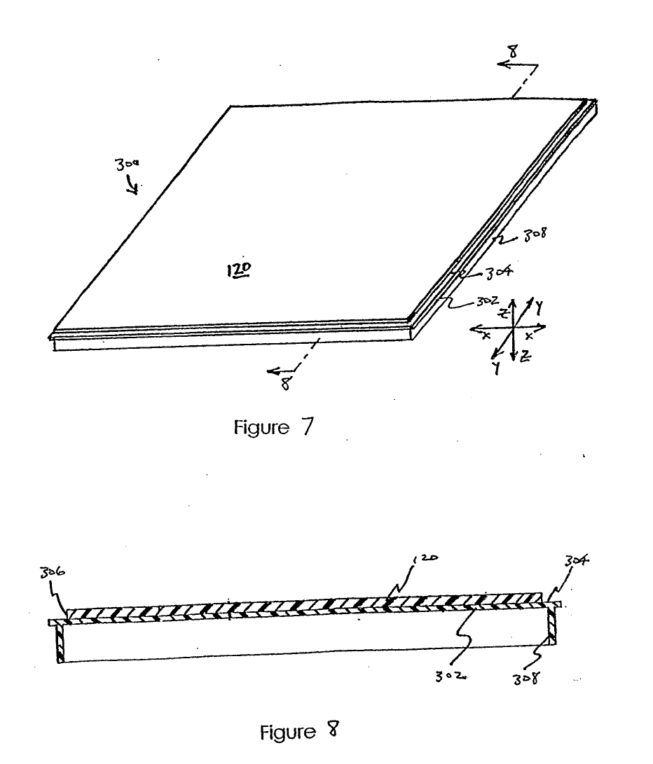

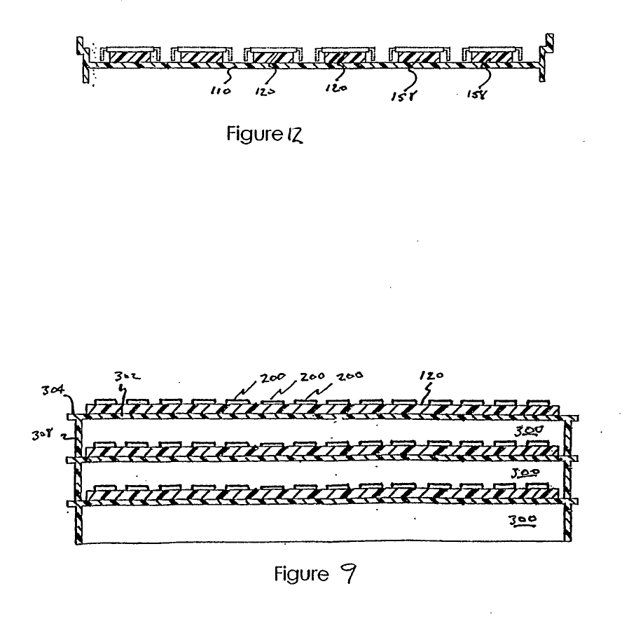

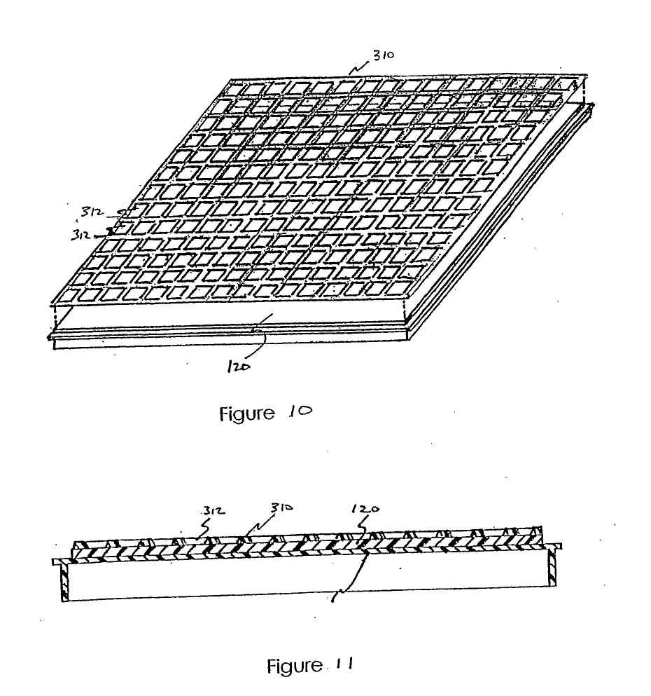

Another embodiment of a carrier 300 according to the present invention is depicted in FIGS. 7 and 8. In this embodiment without pockets, carrier 300 has a rigid body 302 oriented in a plane defined by the “x” and “y” axes as depicted. Rigid body 302 is overlain by electro-active adhesive contact layer 120. Rigid body 302 preferably has a peripheral border region 304 projecting laterally outward beyond the edge 306 of contact layer 120. Body portion 302 may have a downwardly projecting skirt 308. Skirt 308 is positioned so as to engage peripheral border region 304 of another carrier 300 located immediately below when multiple carriers 300 are stacked as depicted in FIG. 9. As an alternative to skirt 308, other structures such as legs or posts may be similarly used to facilitate stacking of multiple carriers 300. Skirt 308 is of sufficient length so that any components 200 disposed on contact layer 120 do not contact any portion of the tray 300 stacked immediately above. Although not necessary for effective retention of components, a separate grid member 310 may be attached over contact layer 120 to define individual component retaining regions 312, as depicted in FIGS. 10 and 11.

The amount of adhesion provided by electro-active adhesive 22 may be reduced by selectively altering the geometry and resulting amount of available component contact area of contact surface 120. This may be accomplished by forming a multiplicity of regular depressions 180 or projections 182 in contact surface 120 as shown in greatly exaggerated fashion for clarity in FIG. 5CC or 5DD, respectively. The depressions 180 or projections 182 may be arranged randomly or in a regular matrix pattern on contact surface 120. The depressions 180 or projections 182 may be from about 0.000040 inch to 0.10 inch in depth or height respectively, and spaced from about 0.000040 inch to about 0.30 inch apart, as may be needed to achieve the desired amount of adhesion. The features may be formed on contact surface 120 by stamping with a mold machined with a negative impression of the desired features. Generally, the mold may be machined using known machining techniques. Photolithography may be used to machine the mold to form regular features at the smaller ends of the ranges. As an alternative, a mold having a fine, random distribution of features may be made by sandblasting, glass beading, or shotpeening the mold surface.

One preferred embodiment of a matrix tray, suitable for bare or leadless devices 208, is shown in FIG. 5A. The electro-active adhesive contact surface 120 is molded over the bottom 104 of each pocket 102 in a continuous layer. As may be seen, a device 208 has a surface 209 in direct contact with contact surface 120. Device 208 is retained in place by adhesion between surface 209 and contact surface 120 exclusively. As depicted, body portion 110 is not in direct contact with device 208 and does not constrain the device. Another embodiment shown in FIG. 5B has contact surface 120 formed as a part of a raised structure 106 within the pocket 102. As illustrated, this structure is particularly suitable for certain types of components 210 having projecting leads 212. It will be appreciated that the invention may include any pocket configuration or structure wherein a electro-active adhesive contact surface having the requisite properties is presented that can be placed into contact with the surface of a device. For instance, as shown in FIG. 12, the tray may include a matrix of platform structures 158 raised above the surface of the body portion of the tray 110 in place of recessed pockets. Contact surface 120 is provided at the top of each structure 158.

Contact surface 120 may be injection overmolded using standard injection molding techniques. Preferably, the materials for surface layer 120 and body portion 110 are selected so that a polar bond is formed during the injection molding process. The two layers may also be mechanically fastened together, or may be secured by a combination of methods. In addition, mechanical bonding structures 160, as shown best in FIG. 5BB, may be provided on body portion 110 to enhance bonding efficacy. In addition, an intermediate or tie layer 170 may be used between the two materials to enhance bonding effectiveness as shown in FIG. 5EE. It is preferred that thermoplastic polymers be used for body portion 110, since thermoplastics tend to offer the general advantages of easier recyclability, greater purity with a smaller process contamination causing sol-fraction, and lower cost. Body portion 110 may be made ESD safe using materials and techniques known in the art. Suitable rigid thermosetting polymers may also be used for body portion 110, but are less preferred.

As understood by those skilled in the art, additional variations of the chemical compositions, and alternative methods of making and using of the electro-active adhesive systems may be practiced within the scope and intent of the present disclosure of the invention. The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention. Furthermore, this invention may be applied in many other industries and is not limited to only semiconductor industry and microelectronic industries.

1. A method of adhesive bonding by electric field, comprising the steps of:
(a) providing at least two adherends to be bonded;
(b) providing an electro-active adhesive system between the at least two adherends, the electro-active adhesive system comprising a plurality of electro-active particles and an adhesive; and
(c) applying an electric field to change the adhesion of the electro-active adhesive system to at least one of the adherends.

2. The method of adhesive bonding of claim 1 wherein the plurality of electro-active particles comprise electrically polarizable particles and the adhesive is an non-curable adhesive where the electrically polarizable particles and the non-curable adhesive constitute an electrorheological fluid.

3. The method of adhesive bonding of claim 2 wherein the electrorheological fluid further comprises a carrier fluid.

4. The method of adhesive bonding of claim 1 wherein the plurality of electro-active particles comprise susceptor particles and the adhesive comprises a surface-responsive material.

5. The method of adhesive bonding of claim 1 wherein the plurality of electro-active particles comprise susceptor particles and the adhesive comprises a shape-memory polymer.

6. The method of adhesive bonding of claim 1 wherein the plurality of electro-active particles comprise susceptor particles and the adhesive comprises a liquid crystal polymer.

7. The method of claim 1 wherein one of the adherends is selected form the group consisting of a matrix tray, a read/write head tray, a chip tray, a carrier tape, a carrier sheet, and a film frame.

8. The method of claim 2 wherein the adherend is made of a material selected from the group consisting of acrylonitrile-butadiene-styrene, polycarbonate, urethane, polyphenylene sulfide, polystyrene, polymethyl methacrylate, polyetherketone, polyetheretherketone, polyetherketoneketone, polyether imide, polysulfone, styrene acrylonitrile, polyethylene, polypropylene, fluoropolymer, polyolefin, nylon, and combinations thereof.

9. The method of claim 1 wherein the adherends comprises a plurality of semiconductor components, microelectronic components, or combinations thereof.

10. A method of adhesive bonding by electric field, comprising the steps of:
(a) providing at least two adherends to be bonded;
(b) providing an electro-active adhesive system between the at least two adherends, the electro-active adhesive system comprising a polymer that is capable to undergo a change in surface roughness under an electric field;
(c) applying an electric field to change the adhesion of the electro-active adhesive system to at least one of the adherends; and
(d) contacting the other adherends to the electro-active adhesive system.

11. The method of claim 10 wherein the polymer is an elastomer.

12. The method of claim 11 wherein the elastomer is selected from a group consisting of poly(dimethyl siloxane), polyisoprene, polybutadiene, styrene-isoprene-styrene block copolymers, polyurethanes, poly(butylene terephthalate), polyolefins, poly(ethylene terephthalate), styrenic block co-polymers, styrene-butadiene rubbers, polyether block polyamides, and polypropylene/crosslinked EDPM rubbers.

13. A carrier for a microelectronic component comprising:
a body portion made from plastic material; and
an electro-active adhesive component contact surface comprising a layer of electro-active adhesive on the body portion for retaining the microelectronic component on the carrier.

14. The carrier of claim 13, wherein the electro-active adhesive comprises a multiplicity of electro-active particles in an adhesive binder.

15. The carrier of claim 14, wherein the electro-active adhesive comprises an electrorheological (ER) fluid.

16. The carrier of claim 14, wherein the electro-active adhesive comprises a surface-responsive material.

17. The carrier of claim 14, wherein the electro-active adhesive comprises a shape-memory polymer.

18. An electro-active adhesive system comprising:
a pair of adherends;
a layer of electro-active adhesive confronting each of the adherends, the electro-active adhesive comprising a multiplicity of electro-active particles in an adhesive binder; and
means for activating the electro-active adhesive to adhere the adherends together.
